(19) United States
(12) Patent Application Publication
(10) Pub. No.: US 2013/0314332 A1
(43) Pub. Date: Nov. 28, 2013

(54) ELECTRONIC DEVICE AND METHOD FOR CLICKING AND POSITIONING MOVABLE OBJECT

(71) Applicant: CHIEN-TE LU, Tu-Cheng (TW)

(72) Inventor: CHIEN-TE LU, Tu-Cheng (TW)

(73) Assignee: HON HAI PRECISION INDUSTRY CO., LTD., Tu-Cheng (TW)

(21) Appl. No.: 13/528,848

(22) Filed: Jun. 21, 2012

(30) Foreign Application Priority Data
May 25, 2012 (TW) 101118617

(51) Int. Cl. G06F 3/041

(52) U.S. Cl. 345/173

(57) ABSTRACT

An electronic device can acquire position coordinates of a central point of a movable object on a touch screen display in response to a user touching a manipulation region of the movable object. The electronic device calculates new position coordinates according to the position coordinates of the central point and preset deviation values, and sets the new position coordinates as present position coordinates of a registration point of the movable object. The registration point of the movable object can be seen throughout by the user when the user select or move the movable object.

### BACKGROUND

1. Technical Field

Embodiments of the present disclosure generally relate to electronic devices, and particularly to an electronic device and a method for clicking and positioning a movable object.

2. Description of Related Art

At present, in image processing software, such as PHOTOSHOP, AUTOCAD, a registration point of a movable object displayed on a touch screen display of an electronic device is positioned at the center of the movable object (as shown in FIG. 8A). When a user wishes to select and move the movable object, fingers of the user touching the touch screen display may cover the registration point (as shown in FIG. 8B), so the user cannot see the exact position where the movable object will be located after the move.

### BRIEF DESCRIPTION OF THE DRAWINGS

FIG. 1 is a schematic diagram of one embodiment of an electronic device.

FIG. 2A-2E are schematic diagrams of embodiments of movable objects.

FIG. 3 is a schematic diagram of position coordinates of the third embodiment in FIG. 2.

FIG. 4 is a block diagram of one embodiment of function modules of a positioning unit of the electronic device in FIG. 1.

FIG. 5 is a flowchart of one embodiment of a method for clicking and positioning a movable object.

FIG. 6 is a schematic diagram of one embodiment of the position coordinates of the movable object in FIG. 3.

FIG. 7A-7B are schematic diagrams of one embodiment of clicking and moving the movable object in FIG. 3.

FIG. 8A-8B are schematic diagrams of one embodiment of clicking and moving a movable object in prior art.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one”.

In general, the word “module”, as used herein, refers to logic embodied in hardware or firmware, or to a collection of software instructions, written in a programming language, such as, Java, C, or assembly. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

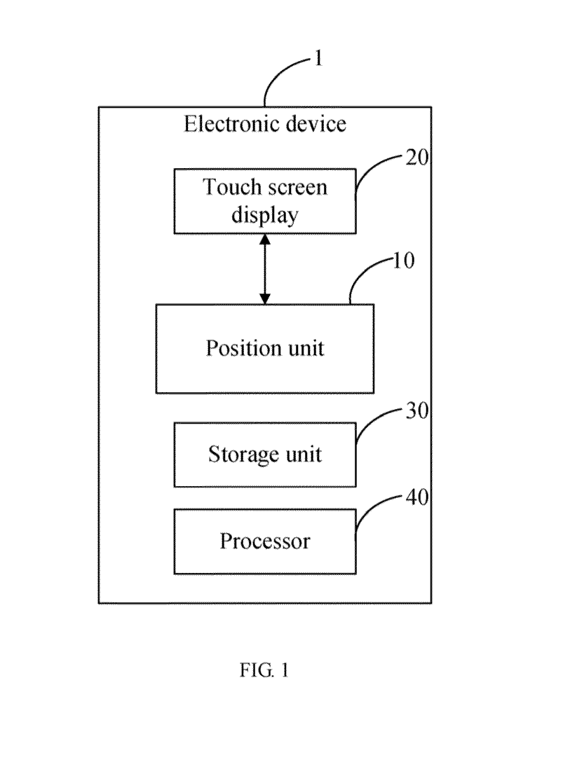

FIG. 1 is a schematic diagram of one embodiment of an electronic device 1. In the embodiment, the electronic device 1 includes a positioning unit 10, a touch screen display 20, a storage unit 30, and a processor 40. The electronic device 1 may be a touch panel computer or a mobile phone, for example. The touch screen display 20 displays a movable object and receives coordinates (first position coordinates) of a finger when a user touches the touch screen display 20 with the finger.

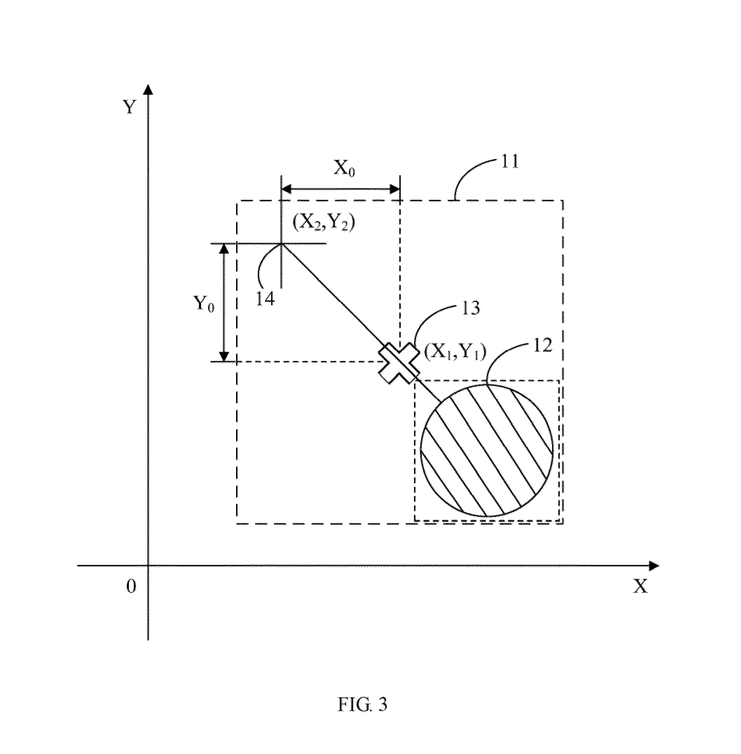

The movable object is an object (such as an icon) that can be moved on the touch screen display 20. In the embodiment, a registration point of the movable object is located outside of a manipulation region of the movable object. The registration point is a position of where the movable object points. The manipulation region is an effective area on the touch screen display 20 where the user can manipulate (such as select and move) the movable object by touching any point in the manipulation region using his/her fingers. In the embodiment, the movable object is an area enclosing the manipulation region and the registration point of the movable object. For example, in FIG. 3, the moveable object 11 encloses the manipulation region 12 and the registration point 14. The manipulation region 12 of the moveable object 11 is a circle, when the user touches the manipulation region 12 with a finger, the user can select or move the movable object 11.

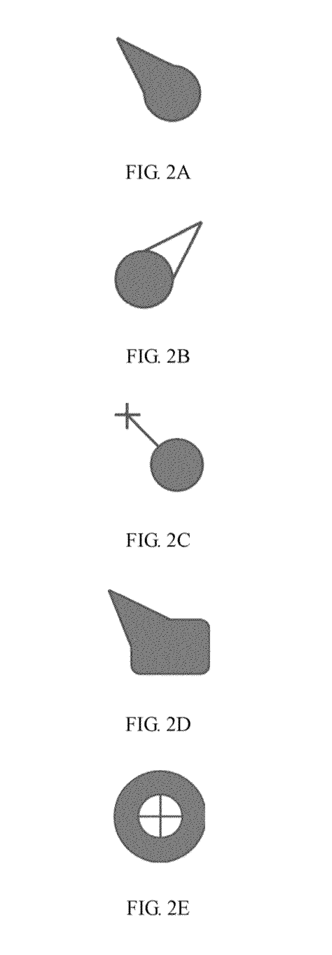

FIG. 2A-2E are schematic diagrams of embodiments of the movable objects. A shaded area of each embodiment in FIG. 2A-2E is the manipulation region of the movable object. In the first embodiment (FIG. 2A) and the fourth embodiment (FIG. 2D), a vertex at a top left corner of the movable object is the registration point. In the second embodiment (FIG. 2B), a vertex at a top right corner of the movable object is the registration point. In the third embodiment (FIG. 2C) and the fifth embodiment (FIG. 2E), a center of a pattern “+” is the registration point. In other embodiments, the movable object which has the registration point located outside of the manipulation region may be in other forms, colors, directions, or sizes.

The positioning unit 10 presets deviation values of the registration point and a central point of the movable object, and calculates position coordinates of the registration point by adding the deviation values to position coordinates of the central point. The central point is a point at the center of the movable object. For example, in FIG. 3, the central point 13 is at the center of the movable object 11, the position coordinates of the central point 13 are (X₁, Y₁), and the preset deviation values are (X₀, Y₀). According to the preset deviation values (X₀, Y₀) and the position coordinates (X₁, Y₁) of the central point 13, the positioning unit 10 can calculate position coordinates (X₂, Y₂) of the registration point 14 by means of applying formulas X₂=X₁+X₀ and Y₂=Y₁+Y₀.

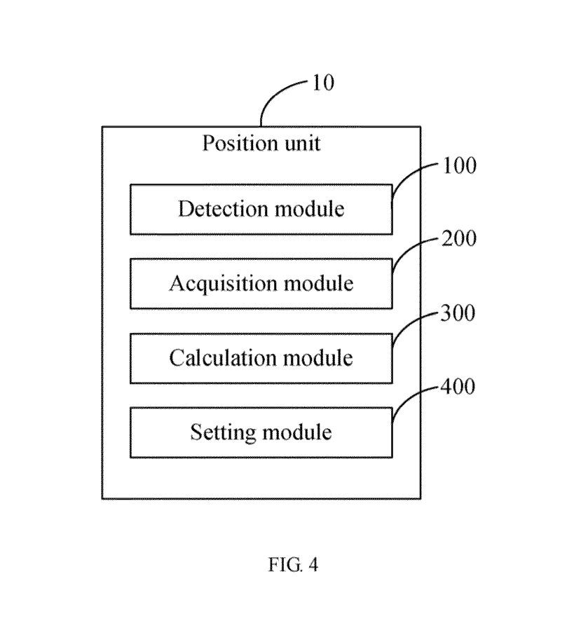

In one embodiment, the positioning unit 10 may include one or more function modules (a description is given in FIG. 4). The one or more function modules may comprise computerized code in the form of one or more programs that are stored in the storage unit 30, and executed by the processor 40 to provide the functions of the positioning unit 10. The storage unit 30 may be a cache or a dedicated memory, such as an EPROM or a flash memory.

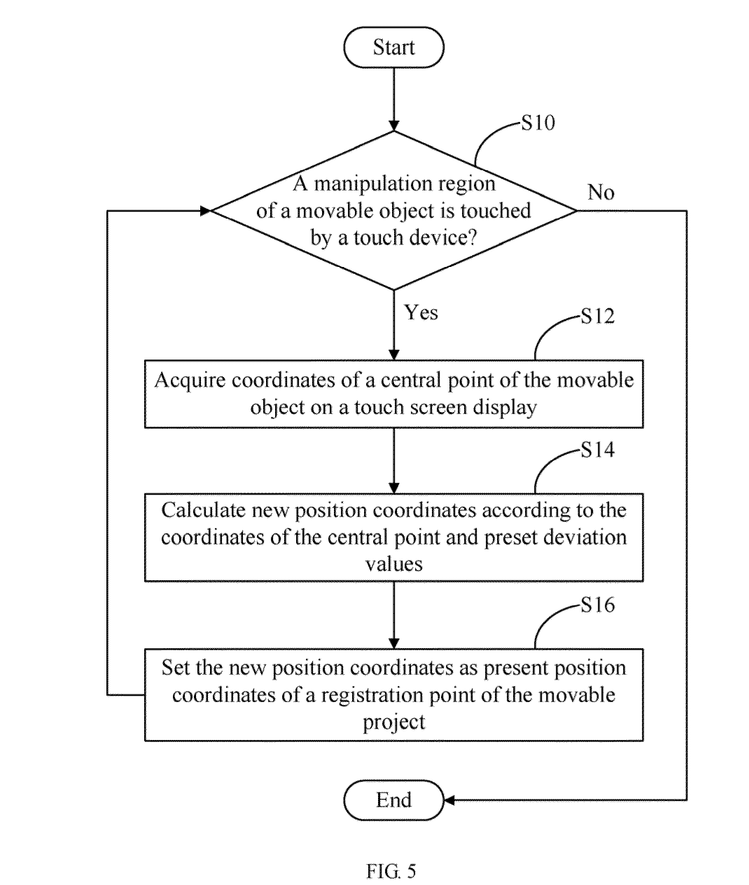

FIG. 4 is a block diagram of one embodiment of the function modules of the positioning unit 10. In one embodiment, the positioning unit 10 includes a detection module 100, an acquisition module 200, a calculation module 300, and a setting module 400. A detailed description of the functions of the modules 100-400 is shown in FIG. 5.

FIG. 5 is a flowchart of one embodiment of a method for clicking and positioning the movable object. Depending on the embodiment, additional steps may be added, others removed, and the ordering of the steps may be changed.

In step S10, the detection module 100 detects a touch by the user on the manipulation region of the movable object with a touch device (such as a finger, a stylus, or an electronic pencil), according to coordinates of a touch point of the touch device on the touch screen display 20 (“first position coordinates”). If the user touches the manipulation region, step S12 is implemented. If the user does not touch the manipulation region, the procedure does not continue.

In step S12, the acquisition module 200 acquires coordinates of the central point of the movable object on the touch screen display 20 (“second position coordinates”). In the embodiment, the touch screen display 20 sends the second position coordinates of the central point of the movable object to the acquisition module 200 when the movable object is displayed on the touch screen display 20.

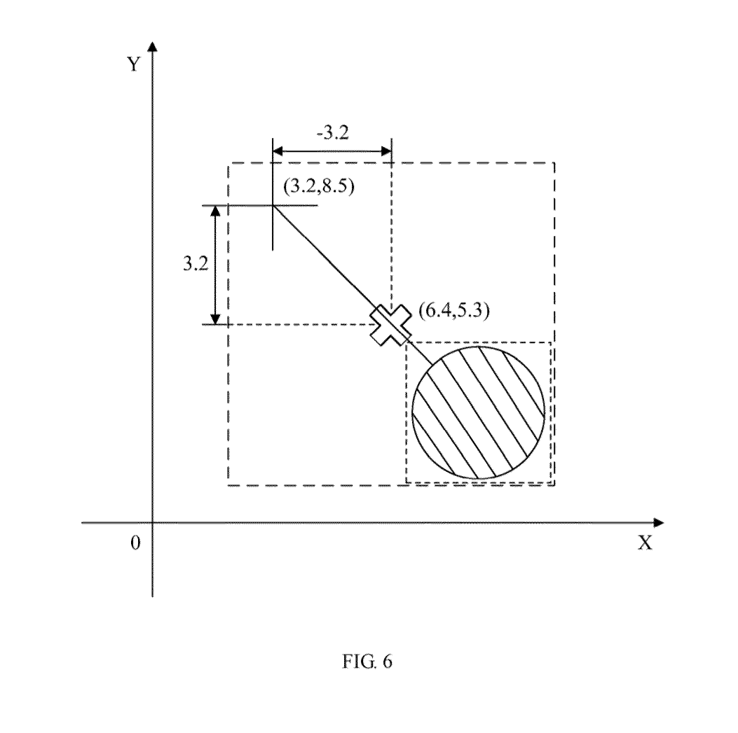

In step S14, the calculation module 300 calculates new position coordinates according to the second position coordinates of the central point and the preset deviation values. For example, in FIG. 6, the second position coordinates of the central point are (6.4, 5.3), and the preset deviation values are (−3.2, 3.2), so the calculated new position coordinates are (3.2, 8.5).

In step S16, the setting module 400 sets the new position coordinates as present position coordinates of the registration point of the movable object.

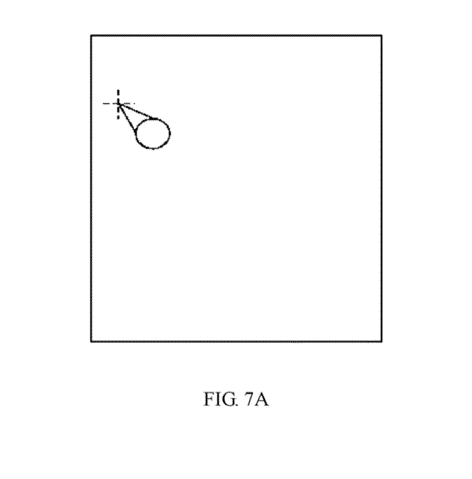

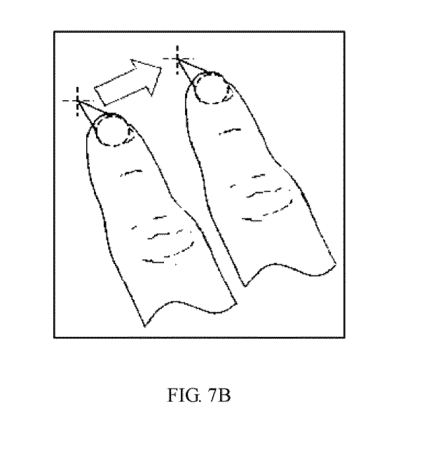

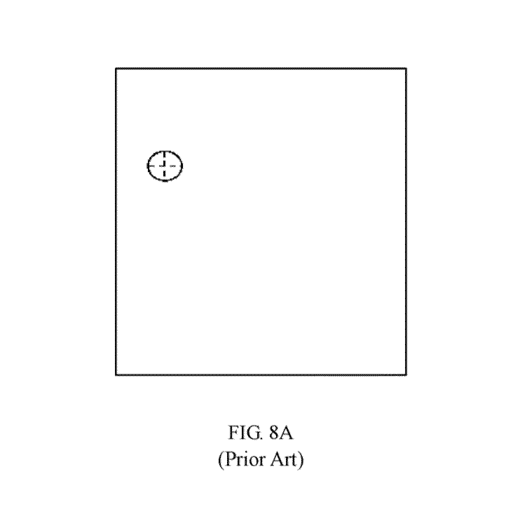

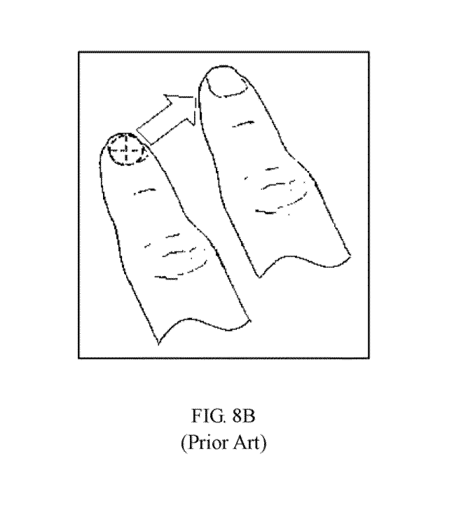

In FIG. 7A, the registration point of the movable object is located outside of the manipulation region. When the user places a finger within the manipulation region to select or move the movable object, the finger does not cover the registration point (as shown in FIG. 7B), so the user can accurately see the position where the movable object points to.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method of an electronic device comprising a touch screen display and a processor, the method comprising:
(a) detecting a touch on a manipulation region of a movable object displayed on the touch screen display, according to first position coordinates of a touch point on the touch screen display;
(b) acquiring second position coordinates of a central point of the movable object on the touch screen display;
(c) calculating, using the processor, new position coordinates according to the second position coordinates of the central point and preset deviation values; and
(d) setting the new position coordinates as present position coordinates of a registration point of the movable object.

2. The method as claimed in claim 1, wherein the registration point of the movable object is located outside of the manipulation region.

3. The method as claimed in claim 2, wherein in step (c), the new position coordinates are calculated by adding the preset deviation values to the second position coordinates of the central point.

4. A non-transitory storage medium storing a set of instructions, the set of instructions capable of being executed by a processor of an electronic device comprising a touch screen display and the processor, the method comprising:
(a) detecting a touch on a manipulation region of a movable object displayed on the touch screen display, according to first position coordinates of a touch point on the touch screen display;
(b) acquiring second position coordinates of a central point of the movable object on the touch screen display;
(c) calculating, using the processor, new position coordinates according to the second position coordinates of the central point and preset deviation values; and
(d) setting the new position coordinates as present position coordinates of a registration point of the movable object.

5. The non-transitory storage medium as claimed in claim 4, wherein the registration point of the movable object is located outside of the manipulation region.

6. The non-transitory storage medium as claimed in claim 5, wherein in step (c), the new position coordinates are calculated by adding the preset deviation values to the second position coordinates of the central point.

7. An electronic device, the electronic device comprising:
a touch screen display;
a storage unit;
at least one processor;
one or more programs that are stored in the storage unit and are executed by the at least one processor, the one or more programs comprising:
a detection module that detects a touch on a manipulation region of a movable object displayed on the touch screen display, according to first position coordinates of a touch point on the touch screen display;
an acquisition module that acquires second position coordinates of a central point of the movable object on the touch screen display;
a calculation module that calculates new position coordinates according to the second position coordinates of the central point and preset deviation values; and
a setting module that sets the new position coordinates as present position coordinates of a registration point of the movable object.

8. The electronic device as claimed in claim 7, wherein the registration point of the movable object is located outside of the manipulation region.

9. The electronic device as claimed in claim 8, wherein the new position coordinates are calculated by adding the preset deviation values to the second position coordinates of the central point.
